(19) United States
(12) Patent Application Publication
(10) Pub. No.: US 2011/0159319 A1
(43) Pub. Date: Jun. 30, 2011

(54) DISK-SHAPED GLASS SUBSTRATE AND METHOD OF MANUFACTURING DISK-SHAPED GLASS SUBSTRATE

(75) Inventors: Tatsuya YAMASAKI, Tokyo (JP); Kazuaki Ishibashi, Ayutthaya (TH)

(73) Assignee: ASAHI GLASS COMPANY, LIMITED, Tokyo (JP)

(21) Appl. No.: 12/977,485

(22) Filed: Dec. 23, 2010

(30) Foreign Application Priority Data
Dec. 25, 2009 (JP) 2009-295978

(51) Int. Cl. G11B 5/82; B26D 3/24; G11B 5/73

(52) U.S. Cl. 428/846.9; 83/55

(57) ABSTRACT

A front end portion of a core drill is formed in an arc shape in which longitudinal cross-sectional portions have the same radius. A contact width of a cutting edge of the core drill which first comes in contact with a surface of the glass sheet is small for the surface of the glass sheet, and the contact width of the cutting edge which comes in contact with the surface of the glass sheet is gradually increased as the core drill is lowered. An annular cavity into which the front end portion of the core drill is inserted is formed on an upper surface of the stage on which the glass sheet is placed. The annular cavity is formed so that its cavity width in the radial direction is wider than a drill width of the core drill.

### TECHNICAL FIELD

The present disclosure relates to a disk-shaped glass substrate and a method of manufacturing a disk-shaped glass substrate, and more particularly, to a method of manufacturing a disk-shaped glass substrate in which a glass sheet is placed on a stage and a disk-shaped glass substrate is formed from the glass sheet with using a cylinder-shaped core drill.

### RELATED ART

In manufacturing a disk-shaped glass substrate with a thickness of 1.5 mm or less, which is used as a glass substrate, for example, for a magnetic recording medium, a glass sheet is placed on a stage, and an operation of forming a disk-shaped glass substrate from the glass sheet with using a cylinder-shaped core drill is performed, thereby processing the disk-shaped glass substrate. The processing operation of the glass substrate for a magnetic recording medium uses a method of processing glass substrates one by one with using a grinding portion of the cylinder-shaped core drill, which is formed by joining abrasive grains at a predetermined ratio, because high processing precision is required.

In addition, in the core drill, diamond abrasive grains are electrodeposited or sintered on a surface of the grinding portion and thus a longitudinal cross-section of the grinding portion is formed in a rectangular shape. A front end portion of the grinding portion of the core drill is made to contact to a surface of the glass sheet while rotating the core drill, and the core drill is moved in an axial direction to gradually deepen processing grooves of the glass sheet. Since the glass sheet is made of a brittle material, during the grinding of the processing grooves, it becomes more important to prevent breaks (chip) due to cracks that occur in the glass sheet or to remove swarf (cullet).

In a method of manufacturing a disk-shaped glass substrate according to the related art, for example, a first processing groove is ground by a first core drill on a lower surface side of a glass sheet, and a second processing groove is then ground by a second core drill with a diameter which is the same as or smaller than that of the first core drill on an upper surface side of the glass sheet. When a bottom portion of the second processing groove is communicated with a bottom portion of the first processing groove, an inner periphery or an outer periphery of the disk-shaped glass substrate is cut out (for example, refer to Patent Document 1). Moreover, an inner peripheral edge or an outer peripheral edge of the disk-shaped glass substrate which is formed from the glass sheet is ground by a grinding wheel, and corner portions of the inner and outer peripheries thereof are subjected to chamfering to finish the inner and outer peripheries into predetermined dimensions.

### RELATED ART DOCUMENT

### Patent Document

[Patent Document 1] JP-A-2006-18922

In the method of manufacturing the disk-shaped glass substrate disclosed in Patent Document 1, in an operation of forming the disk-shaped glass substrate from the glass sheet, in order to prevent chip, the first processing groove on the lower surface side is ground by the first core drill to a depth of almost ½ of a thickness of the glass sheet, and the second processing groove on the upper surface side is then ground by the second core drill to a depth of almost ½ of the thickness of the glass sheet. Therefore, the number of processing operations is increased by the above operations, requiring more time and effort. Thus, there is a problem in that it is difficult to enhance processing efficiency.

In addition, in a case where groove processing is performed only once by the core drill in order to enhance the processing efficiency, a crack occurs in the glass sheet from an inner side of the processing groove immediately before the core drill penetrates through the glass sheet, and significant chip occurs. Therefore, in a case where a thin disk-shaped glass substrate with a thickness of 1.5 mm or less is processed, there is a problem in that processing failure is increased due to an extension of the chip.

In addition, when the disk-shaped glass substrate is formed from the glass sheet, or when an inner end portion and an outer end portion of the disk-shaped glass substrate are subjected to the grinding process, if the disk-shaped glass substrate is placed on the stage again, a fixing position of the disk-shaped glass substrate on the stage is likely to be deviated, and there is a concern that concentricity of the inner periphery and the outer periphery may be decreased after the processing.

### SUMMARY

Exemplary embodiments of the present invention provide a disk-shaped glass substrate and a method of manufacturing a disk-shaped glass substrate in which the above-described problems are solved.

A method of manufacturing a disk-shaped glass substrate, according to the exemplary embodiment of the invention, comprises:

placing a glass sheet with a thickness of 1.5 mm or less on a stage; and

forming a disk-shaped glass substrate from the glass sheet with using a cylinder-shaped core drill,

wherein the core drill has a front end portion configured to form a surface of the glass sheet, the front end portion has a contour shape which is inclined or curved in a radial direction for the surface of the glass sheet, and

wherein an annular cavity into which the front end portion of the core drill is to be inserted is formed on a surface of the stage on which the glass sheet is to be fixed.

In the forming of the disk-shaped glass substrate from the glass sheet with using the core drill, the front end portion of the core drill is inserted into the glass sheet while forming a groove having a shape corresponding to the contour shape of the front end portion on the surface of the glass sheet, and then the front end portion of the core drill penetrates through the glass sheet.

A cavity width of the annular cavity on the stage in a radial direction is wider than a drill width of the core drill in the radial direction by 5% to 50%.

A radius of curvature of the front end portion of the core drill is in a range of 0.1 mm to 0.5 mm.

Diamond abrasive grains are firmly fixed to the surface of the front end portion of the core drill with using metallic bonding, and the drill width of the core drill in the radial direction is in a range of 0.5 mm to 2.0 mm.

The method further comprises:

removing glass cullet, which occurs in the forming of the disk-shaped glass substrate from the glass sheet with using the core drill, from the stage.

The removing of the glass cullet from the stage includes blowing a fluid toward the annular cavity formed on the stage.

The disk-shaped glass substrate is used as a glass substrate for a magnetic recording medium.

The forming of the disk-shaped glass substrate from the glass sheet with using the core drill include at least one of an outside diameter processing or an inside diameter processing of the disk-shaped glass substrate.

The annular cavity on the stage includes an inner peripheral edge portion which has the same dimension as a diameter of an outer periphery of the disk-shaped glass substrate or which is positioned inside the outer periphery of the disk-shaped glass substrate, or includes an outer peripheral edge portion which has the same dimension as a diameter of an inner periphery of the disk-shaped glass substrate or which is positioned outside the inner periphery of the disk-shaped glass substrate.

The annular cavity formed on the stage is provided on the inner peripheral side and/or on the outer peripheral side of the disk-shaped glass substrate, the annular cavity on the inner peripheral side includes a tapered surface in which its inner peripheral edge portion is inclined toward the inside, and

the annular cavity on the outer peripheral side includes a tapered surface in which its outer peripheral edge portion is inclined toward the outside.

The forming of the disk-shaped glass substrate from the glass sheet with using the core drill includes the outside diameter processing and the inside diameter processing of the disk-shaped glass substrate,

the outside diameter processing and the inside diameter processing of the disk-shaped glass substrate are performed on the same stage.

In a disk-shaped glass substrate which is processed by the above-mentioned method, a size of a crack formed on a cut section of the disk-shaped glass substrate in

the forming of a disk-shaped glass substrate from the glass sheet with using the core drill is equal to or smaller than 0.3 mm in a main surface direction of the disk-shaped glass substrate and is equal to or smaller than 0.15 mm in a thickness direction of the disk-shaped glass substrate.

In a disk-shaped glass substrate which is processed by the above-mentioned method, circularity from roundness of an inside diameter of the disk-shaped glass substrate is equal to or smaller than 15 μm, circularity from roundness of an outside diameter of the disk-shaped glass substrate is equal to or smaller than 15 μm, and concentricity of the inside and outside diameters is equal to or smaller than 50 μm.

In a disk-shaped glass substrate which is processed by the above-mentioned method, a size of a crack formed on a cut section of the disk-shaped glass substrate in forming of a disk-shaped glass substrate with using the core drill is equal to or smaller than 0.3 mm in a main surface direction of the disk-shaped glass substrate and is equal to or smaller than 0.15 mm in a thickness direction of the disk-shaped glass substrate, and

circularity from roundness of an inside diameter of the disk-shaped glass substrate is equal to or smaller than 15 μm, circularity from roundness of an outside diameter of the disk-shaped glass substrate is equal to or smaller than 15 μm, and concentricity of the inside and outside diameters is equal to or smaller than 50 μm.

A glass substrate for a magnetic recording medium, has a disk shape with a circular hole in a center portion,

wherein circularity from roundness of an inside diameter of the glass substrate for a magnetic recording medium is equal to or smaller than 15 μm, circularity from roundness of an outside diameter of the glass substrate for a magnetic recording medium is equal to or smaller than 15 μm, and concentricity of the inside and outside diameters is equal to or smaller than 50 μm.

According to the exemplary embodiment, the front end portion of the core drill has a contour shape inclined or curved in the radial direction for the surface of the glass sheet. The annular cavity into which the front end portion of the core drill is inserted is formed on the surface of the stage on which the glass sheet is fixed. The front end portion is inserted into the glass sheet while forming the groove in the contour shape of the front end portion of the core drill on the surface of the glass sheet and then the front end portion penetrates through the glass sheet. Therefore, the inner periphery and/or the outer periphery of the disk-shaped glass substrate are formed by a single processing, so that the processing efficiency of the core drill can be increased, and chip that occurs on the rear surface side of the glass sheet can be reduced. Therefore, a size of a break (chip) due to the crack generation that occurs when a thin disk-shaped glass substrate having a thickness of 1.5 mm or less is ground by the core drill can be suppressed to be in the range of the grinding allowance in subsequent operations, thereby significantly reducing a ratio of failure due to the chip.

The inner and outer peripheries of the disk-shaped glass substrate can be processed by the core drill while the glass sheet is fixed on the same stage, so that concentricity of the inner and outer peripheries of the processed disk-shaped glass substrate can be further increased.

### BRIEF DESCRIPTION OF THE DRAWINGS

FIG. 1 is an enlarged longitudinal cross-sectional view illustrating a core drill used for a method of manufacturing a disk-shaped glass substrate according to the invention.

FIG. 2 is a flowchart showing procedures of a forming operation A using the method of manufacturing a disk-shaped glass substrate according to the invention.

FIG. 3A is a longitudinal cross-sectional view schematically illustrating a state of the core drill illustrated in FIG. 1 during processing.

FIG. 3B is a longitudinal cross-sectional view schematically illustrating a state where the front end portion of the core drill illustrated in FIG. 1 goes through the glass sheet.

FIG. 3C is a longitudinal cross-sectional view schematically illustrating a correction operation performed by the core drill illustrated in FIG. 1.

FIG. 3D is a longitudinal cross-sectional view schematically illustrating a processing end of the core drill illustrated in FIG. 1.

FIG. 4 is a diagram illustrating the state where the front end portion of the core drill penetrates through the glass sheet.

FIG. 5 is an enlarged longitudinal cross-sectional view illustrating a relationship between a processing allowance of the inner or outer peripheral portion of the glass sheet and chip.

FIG. 6 is a flowchart showing procedures of a forming operation B using the method of manufacturing a disk-shaped glass substrate according to the invention.

FIG. 7 is a flowchart showing procedures of a forming operation C using the method of manufacturing a disk-shaped glass substrate according to the invention.

FIG. 8 is a longitudinal cross-sectional view illustrating a first modified example of the core drill.

FIG. 9 is a longitudinal cross-sectional view illustrating a second modified example of the core drill.

FIG. 10 is a longitudinal cross-sectional view illustrating a third modified example of the core drill.

FIG. 11 is a diagram illustrating an operation of removing cullet (swarf) on the stage.

FIG. 12 is a longitudinal cross-sectional view illustrating a modified example of the annular cavity formed on the stage.

FIG. 13 is a longitudinal cross-sectional view illustrating a core drill and the stage for processing the inner and outer peripheries of the disk-shaped glass substrate.

FIG. 14 is a longitudinal cross-sectional view illustrating a state where the inner periphery and the outer periphery of the disk-shaped glass substrate are processed with using the core drill illustrated in FIG. 13.

FIG. 15 is a longitudinal cross-sectional view illustrating a modified example of the annular cavity formed on the stage when the inner and outer peripheries of the disk-shaped glass substrate are processed with using the core drill.

FIG. 16 is a longitudinal cross-sectional view illustrating a state where the inner and outer peripheries of the disk-shaped glass substrate are processed with using the core drill illustrated in FIG. 15.

### DETAILED DESCRIPTION

Hereinafter, exemplary embodiments of the invention will be described with reference to the accompanying drawings.

### Embodiment 1

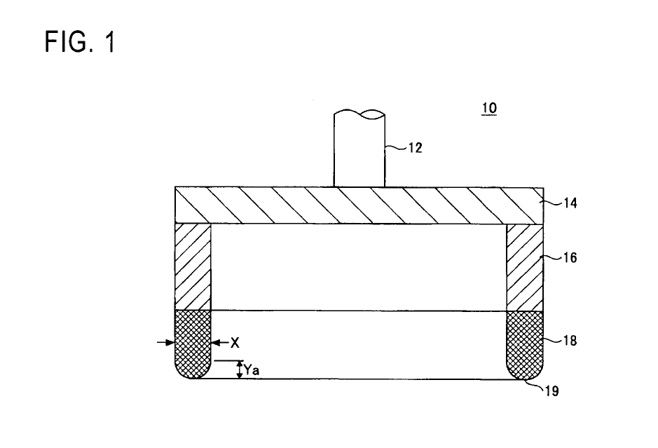

FIG. 1 is an enlarged longitudinal cross-sectional view illustrating a core drill used for a method of manufacturing a disk-shaped glass substrate according to the invention. As illustrated in FIG. 1, the core drill 10 is a grinding drill for grinding a processing groove at a position corresponding to an inner periphery or an outer periphery of a disk-shaped glass substrate. The core drill 10 includes a rotation shaft 12, a supporting plate 14, a cylindrical portion 16, and a grinding portion 18. The rotation shaft 12, the supporting plate 14, and the cylindrical portion 16 are formed of a metallic material such as stainless steel and are driven to rotate by a motor driving unit such as a drilling machine which is supported so as to be able to elevate.

The grinding portion 18 is formed by firmly fixing, for example, diamond abrasive grains to its surface using metallic bonding and thus a layer of the diamond abrasive grains is thicker than that formed by electrodeposition. The grinding portion 18 is integrally fixed to an end portion of the cylindrical portion 16 so as to have a diameter corresponding to an inner periphery or an outer periphery of a glass substrate for magnetic recording which becomes a final product. That is, in order to actually manufacture the core drill 10, the grinding portion 18 is formed allowing processing allowances to be ground and polished by a chamfering operation and an operation of grinding end surfaces to remain.

A front end portion 19 of the grinding portion 18 is formed in an arc shape in which longitudinal cross-sectional portions have the same radius. That is, the front end portion 19 of the grinding portion 18 has a contour shape which is curved in a radial direction for a surface of a glass sheet.

The front end portion 19 is formed to have an axial height Ya, and when the disk-shaped glass substrate is formed by processing grooves on the glass sheet, the front end portion 19 is inserted until the portion of the height Ya penetrates through the glass sheet and protrudes from a lower surface of the glass sheet.

According to this embodiment, to a surface of the grinding portion 18 of the core drill 10, diamond abrasive grains are firmly fixed using metallic bonding. Accordingly, the core drill 10 can be formed so that a layer of the diamond abrasive grains of the grinding portion 18 is thicker than that formed by diamond electrodepositing, thereby enhancing durability of grinding.

In addition, grain sizes of the diamond abrasive grains of the grinding portion 18 may be in the range of fine count #100 to #400. Accordingly, the diamond abrasive grains of the core drill 10 are fine, thereby crack generation is suppressed when a thin glass sheet with a thickness of 1.5 mm or less is ground by the grinding portion 18. In addition, in a case where the diamond abrasive grains of the grinding portion 18 exceed fine count #400, since the diamond abrasive grains are too fine, there are concerns that clogging and a reduction in grinding speed are likely to occur, and productivity is degraded.

A drill width (thickness) X of the grinding portion 18 in the radial direction is in the range of 0.5 mm to 2.0 mm, and a radius of curvature of the front end portion 19 of the grinding portion 18 is in the range of 0.1 mm to 0.5 mm. Accordingly, the front end portion 19 of the grinding portion 18 is formed to be ultrafine, and thus stress applied to the surface of the glass sheet is reduced when the thin glass sheet having a thickness of 1.5 mm or less is ground. Therefore, chip that may occur is reduced and thus confined to the drill width X, so that it is possible to process the thin glass sheet at high precision.

In a case where the drill width of the grinding portion 18 in the radial direction is smaller than 0.5 mm, strength of the core drill 10 is insufficient and durability is degraded. In addition, in a case where the drill width is wider than 2.0 mm, a peripheral speed difference occurs between the inner and outer peripheries of the grinding portion 18 during grinding, and a front end shape of the grinding portion 18 is deformed, so that it is difficult to perform grinding with stable quality. Moreover, in a case where the radius of curvature of the front end portion 19 of the grinding portion 18 is smaller than 0.1 mm, there is a concern that an effect of suppressing a break (chip) due to crack generation may be reduced.

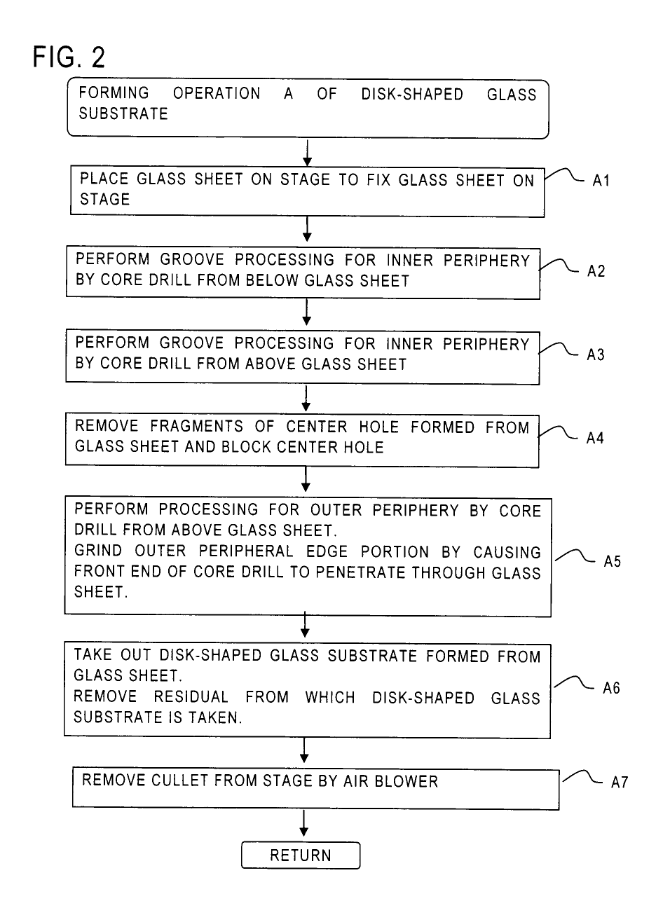

Here, each procedure of a forming operation A of the disk-shaped glass substrate will be described with reference to FIG. 2. FIG. 2 is a flowchart showing procedures of the forming operation A using the method of manufacturing a disk-shaped glass substrate according to the invention.

As shown in FIG. 2, first, a glass sheet before being subjected to processing is placed on a stage of an apparatus for processing a disk-shaped glass substrate, and the glass sheet is vacuumed to be fixed on the stage (Procedure A1).

Next, groove processing for an inner periphery of a center hole to be provided in the disk-shaped glass substrate is performed by a lower-side small-diameter core drill manufactured for processing an inner periphery from below the glass sheet (Procedure A2). Since a front end portion of the core drill is rectangular, in order to prevent breaks (chip), the groove processing is performed two times, that is, from above and from below. In Procedure A2, when the front end portion reaches about ½ of the thickness of the glass sheet or deeper, the processing is stopped and the core drill is separated from the glass sheet. In addition, in the operation of grinding the glass sheet, a grinding fluid such as a coolant is supplied to cool processed portions with which the grinding portion of the core drill comes in contact with.

Next, groove processing for the inner periphery of the center hole to be provided in the disk-shaped glass substrate is performed by an upper-side small-diameter core drill manufactured for processing the inner periphery from above the glass sheet (Procedure A3). In Procedure A3, the processing is stopped when the front end portion of the core drill reaches about ½ of the thickness of the glass sheet or deeper, and the core drill is separated from the glass sheet. Accordingly, the two grooves processed in the up and down directions are communicated with each other, thereby terminating the forming of the inner periphery.

Next, fragments of the center hole formed from the glass sheet are removed, and in order to prevent the grinding fluid from flowing through the center hole, the center hole is blocked by a circular member lifted from below (Procedure A4). Accordingly, when the outer periphery of the disk-shaped glass substrate is ground in the subsequent operation, the grinding fluid is sufficiently supplied to the outer peripheral side.

Next, groove processing for the outer periphery of the disk-shaped glass substrate is performed by the core drill 10 with a large diameter from above the glass sheet (Procedure A5). In addition, in Procedure A5, the front end portion 19 of the core drill 10 is allowed to penetrate through the glass sheet and lowered to a position inserted into an annular cavity formed on the stage. Accordingly, an outer peripheral end portion of the disk-shaped glass substrate is ground at high precision. Thereafter, the core drill 10 is lifted so as to be separated from the glass sheet. Accordingly, the disk-shaped glass substrate (product) having a circular center hole at the center portion of the glass sheet is formed. As such, the processing for the outer periphery of the disk-shaped glass substrate is terminated by a single processing with using the core drill 10.

Next, the disk-shaped glass substrate (product) is extracted from the glass sheet, and the residue of the glass sheet from which the disk-shaped glass substrate is extracted is removed from the stage (Procedure A6). The extracted disk-shaped glass substrate is transported to be subjected to a subsequent operation (chamfering of the inner periphery and the outer periphery, or grinding of the inner periphery, the outer periphery, and upper and lower surfaces of the substrate).

Next, swarf (cullet) remaining on the stage is removed by an air blower (Procedure A7). The air blower blows a spiral air flow toward the stage while turning an air nozzle to effectively blow the swarf on the stage upwards. Furthermore, a gas other than compressed air (for example, nitrogen gas) may be blown toward the stage, or, instead of the air blower, a liquid (fluid) such as a cutting fluid or a wash fluid may be sprayed toward the stage to remove the swarf from the stage.

In a case where the processing of the disk-shaped glass substrate is performed in the procedures of the forming operation A shown in FIG. 2, a size of a crack formed on a cut section of the disk-shaped glass substrate is equal to or smaller than 0.3 mm in a main surface direction and equal to or smaller than 0.15 mm in a thickness direction of the disk-shaped glass substrate. Such a size can be easily removed in subsequent operations.

In addition, circularity from roundness of an inside diameter of the disk-shaped glass substrate (a difference between a minimum value of the inside diameter and a maximum value thereof) is equal to or smaller than 15 μm, circularity from roundness of an outside diameter (a difference between a minimum value of the outside diameter and a maximum value thereof) is equal to or smaller than 15 μm, and concentricity of the inside diameter and the outside diameter (a distance between the center of the inside diameter and the center of the outside diameter) is equal to or smaller than 50 μm. As such, circularity from roundness and concentricity in the case where the processing of the disk-shaped glass substrate is performed in the procedures of the forming operation A shown in FIG. 2 can obtain higher precision.

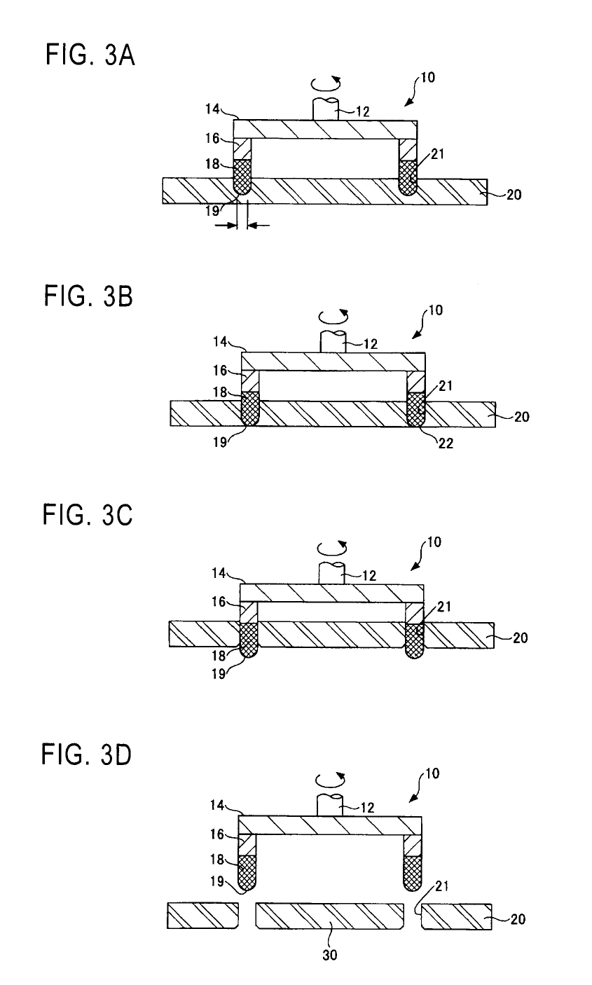

Here, a grinding operation (forming operation) performed by the core drill 10 will be described with reference to FIGS. 3A to 3D. Furthermore, in FIGS. 3A to 3D, groove processing for an inner peripheral side to be performed on a glass sheet 20 in Procedures A2 and A3 is omitted.

FIG. 3A is a longitudinal cross-sectional view schematically illustrating a state of the core drill illustrated in FIG. 1 during processing. As illustrated in FIG. 3A, during processing, the core drill 10 is lowered while being rotated to cause the front end portion 19 of the grinding portion 18 to come in contact with the surface of the glass sheet 20. In addition, in the operation of grinding the glass sheet 20, a grinding fluid such as a coolant is supplied to processed regions with which the front end portion 19 of the grinding portion 18 of the core drill 10 come in contact.

The front end portion 19 of the grinding portion 18 has an arc shape and thus is curved for the surface of the glass sheet 20. Accordingly, a contact width of a cutting edge which first comes in contact with the surface of the glass sheet 20 is small for the surface of the glass sheet 20, and the contact width of the cutting edge of the core drill 10 which comes in contact with the surface of the glass sheet 20 is gradually increased as the core drill 10 is lowered. Therefore, at the start of grinding, a load applied to the glass sheet 20 is small, and even though the contact width of the cutting edge of the core drill 10 is increased during the grinding operation, a crack is less likely to occur in the glass sheet 20.

FIG. 3B is a longitudinal cross-sectional view schematically illustrating a state where the front end portion of the core drill illustrated in FIG. 1 goes through the glass sheet. As illustrated in FIG. 3B, as the front end portion 19 of the grinding portion 18 moves in the thickness direction of the glass sheet 20 while being rotated, a processing groove 21 having a bottom portion corresponding to the contour shape (arc shape) of the front end portion 19 of the grinding portion 18 is processed on the glass sheet 20. Therefore, the bottom portion of the processing groove 21 has a curved shape (arc shape), so that stress concentration on the processed surface does not occur and crack generation is suppressed during processing. Although a crack occurs, most of the cracking is confined to the drill width and thus can be corrected.

Here, operations of the core drill 10 will be described compared to those according to the related art.

With regard to a core drill according to the related art, in a case where a front end portion of a grinding portion comes in contact with and grinds a planar surface of a glass sheet, since a cross-sectional shape of the front end portion of the grinding portion is rectangular, a crack is more likely to occur at points corresponding to corners of the rectangular shape in a processing groove part formed on the glass sheet. Therefore, in the case where the core drill according to the related art is used, before the front end portion of the grinding portion reaches a lower surface of the glass sheet, the crack that occurs in the processing groove progresses in an inclination direction, and when the crack reaches the lower surface of the glass sheet, a part of the lower surface side is peeled off and falls (a chip generation phenomenon). In addition, in the core drill according to the related art, since the cross-sectional shape of the front end portion of the grinding portion is rectangular, a width of the front end portion is the same as the drill width and thus the generated chip cannot be corrected.

Contrary to this, in the core drill 10 according to the present invention, the front end portion 19 of the grinding portion 18 has an arc shape, so that stress concentration does not occur in a wall surface (processed surface) of the processing groove 21 and crack generation is suppressed during processing. Although a crack occurs, most of the cracking is confined to the drill width, so that chip of a size which would cause a problem in subsequent operations hardly occurs.

FIG. 3C is a longitudinal cross-sectional view schematically illustrating a correction operation performed by the core drill illustrated in FIG. 1. As illustrated in FIG. 3C, when the front end portion 19 of the grinding portion 18 is lowered to a position to penetrate through the glass sheet 20, since the grinding portion 18 of the core drill 10 has an inner peripheral surface and an outer peripheral surface extending in an axial direction, an inner peripheral wall and an outer peripheral wall of the processing groove 21 are also ground. Accordingly, a thin residual portion 22 (an outer portion of the contour shape of the front end portion 19 illustrated in FIG. 3B) which is not processed by the front end portion 19 of the grinding portion 18 and thus remains at the bottom portion of the processing groove 21 is ground.

Furthermore, the residual portion 22 is connected to the lower surface side of the glass sheet 20 and thus is removed by the inner and outer peripheral surfaces of the grinding portion 18 as the front end portion 19 of the grinding portion 18 penetrates through the glass sheet 20. Therefore chip in which the residual portion 22 is peeled from the lower surface side of the glass sheet 20 is suppressed or corrected.

FIG. 3D is a longitudinal cross-sectional view schematically illustrating a processing end of the core drill illustrated in FIG. 1. As illustrated in FIG. 3D, after the front end portion 19 of the grinding portion 18 penetrates through the glass sheet 20, the core drill 10 is moved upward so that the grinding portion 18 is separated from the glass sheet 20. Accordingly, the processing performed by the core drill 10 in Procedure A5 is terminated, and thus the disk-shaped glass substrate 30 can be extracted. As such, the disk-shaped glass substrate 30 formed from the glass sheet 20 is used as a glass substrate for a magnetic recording medium.

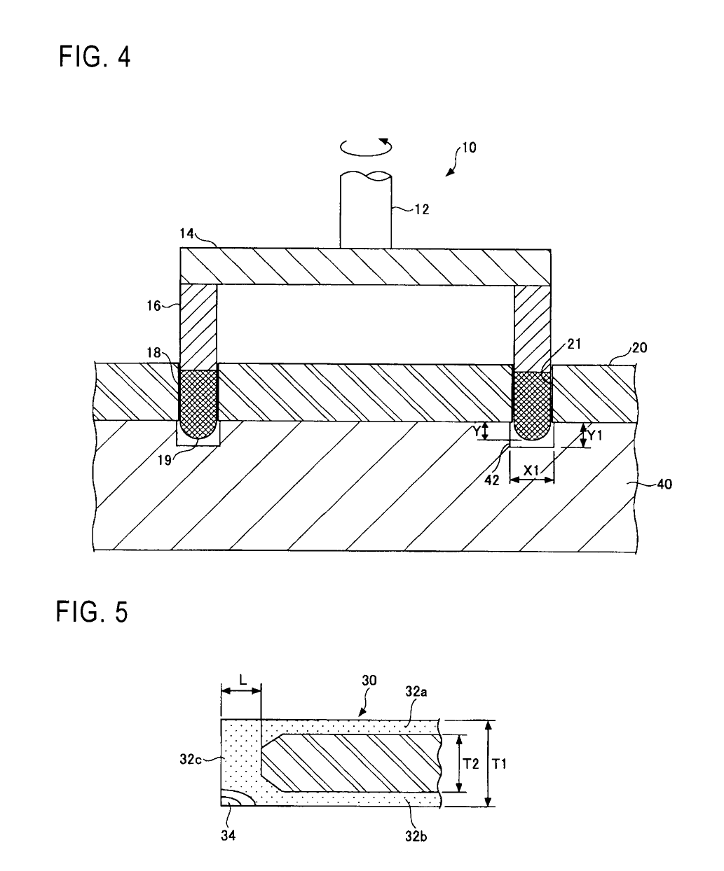

Here, a state where the front end portion 19 of the core drill 10 goes through the glass sheet 20 will be described. FIG. 4 is a diagram illustrating the state where the front end portion of the core drill penetrates through the glass sheet. As illustrated in FIG. 4, the processing by the core drill 10 is performed in a state that the glass sheet 20 is placed on a stage 40. The stage 40 is a plate made of a metallic material or a thin rubber or resin attached to a metallic material and has a fixing hole for vacuuming the placed glass sheet 20 to be fixed.

An upper surface of the stage 40 on which the glass sheet 20 is placed is provided with an annular cavity 42 into which the front end portion 19 of the core drill 10 is inserted. In a case where the groove processing for the inner peripheral side of the disk-shaped glass substrate 30 is performed, the annular cavity 42 is provided to have an outer peripheral edge portion which has the same dimension as the diameter of the inner periphery of the disk-shaped glass substrate 30 or which is positioned outside the inner periphery of the disk-shaped glass substrate 30. In a case where the groove processing for the outer peripheral side of the disk-shaped glass substrate 30 is performed, the annular cavity 42 is provided to have an inner peripheral edge portion which has the same dimension as the diameter of the outer periphery of the disk-shaped glass substrate 30 or which is positioned inside the outer periphery of the disk-shaped glass substrate 30. That is, the upper surface of the stage 40 supports the lower surface of the glass sheet 20 such that chip is less likely to expand under the stress during the grinding operation when the front end portion 19 of the core drill 10 penetrates through the glass sheet 20 and is inserted into the annular cavity 42.

The annular cavity 42 is formed so that its cavity width X1 in the radial direction is wider than the drill width X (in this embodiment, X=0.5 mm to 2.0 mm) of the front end portion 19 of the core drill 10 so as not to come in contact with the front end portion 19 of the core drill 10 (X1>X). In this embodiment, the annular cavity 42 may be set so that the cavity width X1 in the radial direction is wider than the drill width X of the grinding portion 18 of the core drill 10 in the radial direction by 5% to 50%.

Either the inner or outer peripheral edge portion of the annular cavity 42 (edge portions at the upper surface of the stage 40) is positioned either very slightly more inner or outer respectively than the drill width X of the grinding portion 18 of the core drill 10, so that it is possible to suppress the chip from expanding when the front end portion 19 of the core drill 10 penetrates through the glass sheet 20.

A depth Y1 of the annular cavity 42 in the up and down direction is wider than a protruding amount Y (in this embodiment, Y=0.1 mm to 0.5 mm) of the front end portion 19 of the core drill 10 protruding downward from the lower surface of the glass sheet 20 (Y1>Y).

Accordingly, when the front end portion 19 of the grinding portion 18 penetrates through the processing groove 21 while grinding the processing groove 21 in the glass sheet 20, swarf (cullet) due to the grinding falls in the annular cavity 42 and is prevented from scattering in the vicinity thereof.

In addition, since the annular cavity 42 is formed on the stage 40, the front end portion 19 of the core drill 10 is allowed to penetrate through the glass sheet 20. The inner and outer peripheral surfaces of the grinding portion 18 grind the inner and outer peripheral walls of the processing groove 21 while the front end portion 19 penetrates therethrough, so that it is possible to remove chip that may occur on the lower surface side of the glass sheet 20.

Moreover, even in the grinding operation illustrated in FIG. 4, the glass sheet 20 is continuously held while being placed on the stage 40 during a correction operation performed by the inner and outer peripheral walls of the front end portion 19 of the core drill 10. Therefore, it is possible to sufficiently add (supply) the grinding fluid such as a coolant to the inner and outer peripheral surfaces of the grinding portion 18 of the core drill 10.

FIG. 5 is an enlarged longitudinal cross-sectional view illustrating a relationship between a processing allowance of the inner or outer peripheral portion of the glass sheet and chip. As illustrated in FIG. 5, the disk-shaped glass substrate 30 formed from the glass sheet 20 includes processing allowances 32a and 32b ground on the upper surface side and the lower surface side and a processing allowance 32c in the inner and outer peripheral edges in the radial direction. In FIG. 5, the processing allowances 32a, 32b, and 32c are shown as a pear-skin pattern.

Each of the processing allowances 32a and 32b on the upper and lower surface sides is (T1−T2)/2, and the processing allowance 32c of the inner or outer peripheral edge is L. In this embodiment, for example, when it is assumed that T1=1.28 mm, T2=0.84 mm, and L=0.58 mm, chip 34 is equal to or smaller than 0.3 mm×0.15 mm (main surface direction×thickness direction). Furthermore, in this embodiment, a dimension of the main surface direction×the thickness direction as a size of the chip 34 is preferably equal to or smaller than 0.2 mm×0.10 mm, and more preferably, is equal to or smaller than 0.1 mm×0.05 mm.

That is, in the processing operation of grinding the processing groove 21 in the glass sheet 20 by the core drill 10, as the front end portion 19 of the grinding portion 18 penetrates through the glass sheet 20, it is possible to suppress the chip 34 that occurs on the lower surface side of the processing groove 21 to be smaller than the ranges of the processing allowances 32a, 32b, and 32c.

Therefore, in the operation of forming the disk-shaped glass substrate 30 with using the core drill 10, the size of the crack formed in the cut section of the disk-shaped glass substrate 30 is equal to or smaller than 0.3 mm in the main surface direction of the disk-shaped glass substrate 30 and is equal to or smaller than 0.15 mm in the thickness direction of the disk-shaped glass substrate 30.

In addition, by the operation of forming the disk-shaped glass substrate 30 with using the core drill 10, circularity from roundness of the inside diameter of the disk-shaped glass substrate 30 is equal to or smaller than 15 μm, and circularity from roundness of the outside diameter is equal to or smaller than 15 μm, and concentricity of the inside diameter and the outside diameter is equal to or smaller than 50 μm.

Furthermore, in this embodiment, a value of the circularity from roundness of the inside diameter of the disk-shaped glass substrate 30 is preferably equal to or smaller than 10 μn, and more preferably equal to or smaller than 8 μm. A value of the circularity from roundness of the outside diameter thereof is preferably equal to or smaller than 10 μm, and more preferably equal to or smaller than 8 μm. A value of the concentricity of the disk-shaped glass substrate 30 is preferably equal to or smaller than 40 μm, and more preferably equal to or smaller than 30 μm.

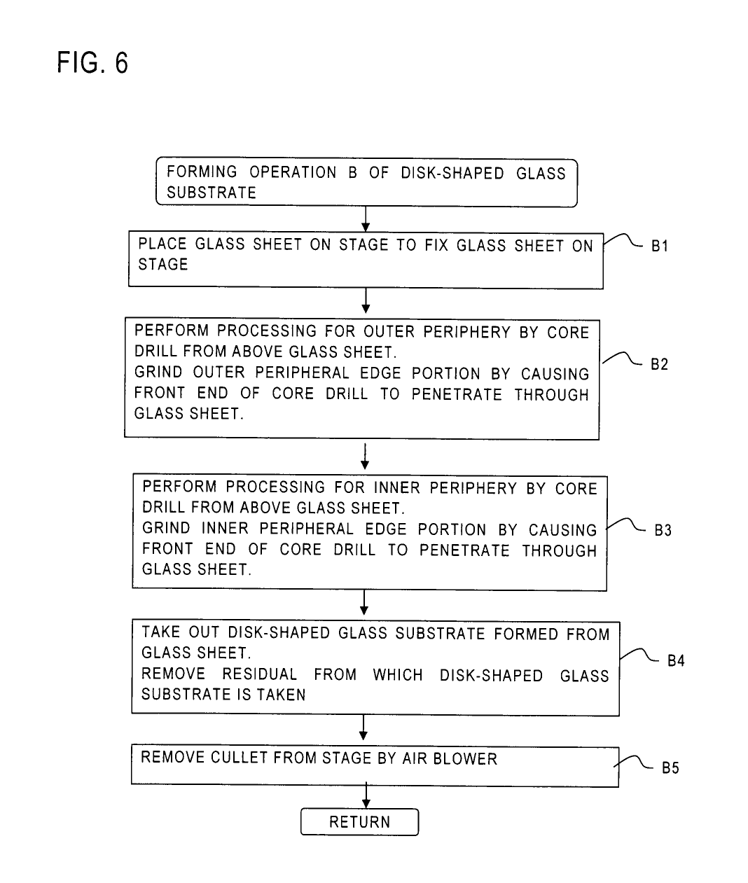

Here, a forming operation B according to a modified example will be described. FIG. 6 is a flowchart showing procedures of the forming operation B using the method of manufacturing a disk-shaped glass substrate according to the invention.

As shown in FIG. 6, first, the glass sheet 20 before being subjected to processing is placed on the stage 40 of the apparatus for processing a disk-shaped glass substrate, and the glass sheet 20 is vacuumed to be fixed on the stage 40 (Procedure B1).

Next, groove processing for an outer periphery to be provided in the disk-shaped glass substrate 30 is performed by a large-diameter core drill for processing an outer periphery from above the glass sheet 20 (Procedure B2). The large-diameter core drill is formed so that a front end portion of a grinding portion has a contour shape curved into an arc shape like the front end portion 19 of the grinding portion 18 of the above-mentioned core drill 10. In addition, in an operation of grinding the glass sheet, a grinding fluid such as a coolant is supplied to cool processed portions with which the grinding portion of the core drill come in contact.

In addition, in Procedure B2, the front end portion 19 of the large-diameter core drill is lowered to a position so as to penetrate through the glass sheet 20 and be inserted into the annular cavity 42 formed on the stage 40, and thereafter the large-diameter core drill is lifted so as to be separated from the glass sheet 20. Processing for the outer periphery of the disk-shaped glass substrate 30 is terminated by a single processing with using the large-diameter core drill.

Furthermore, the disk-shaped glass substrate 30 of which the outer periphery is processed by the large-diameter core drill is not extracted from the stage 40 and is subjected to inner periphery processing as it is. This is because concentricity of the inner and outer peripheries is deviated when the disk-shaped glass substrate 30 of which the outer periphery is processed is extracted once and the stage is changed. Accordingly, in this embodiment, the outer periphery processing and the inner periphery processing are performed on the same stage. The residue from the disk-shaped glass substrate 30 may not be removed. For enhancement of the concentricity, the same stage 40 on which the disk-shaped glass substrate 30 is placed is used until the outer periphery processing and the inner periphery processing are ended.

Next, groove processing for the inner periphery of the disk-shaped glass substrate 30 is performed from above the glass sheet 20 by a small-diameter core drill for the inner periphery processing which is manufactured to have a smaller diameter than the core drill for the outer periphery processing (Procedure B3). The small-diameter core drill is formed so that a front end portion of a grinding portion has a contour shape curved into an arc shape like the front end portion 19 of the grinding portion 18 of the above-mentioned core drill 10.

In addition, in Procedure B3, the front end portion 19 of the small-diameter core drill is lowered to a position so as to penetrate through the glass sheet 20 and be inserted into the annular cavity 42 formed on the stage 40, and thereafter the small-diameter core drill is lifted so as to be separated from the glass sheet 20. Processing for the inner periphery of the disk-shaped glass substrate 30 is terminated by a single processing with using the small-diameter core drill.

In addition, in Procedure B3, since the front end portion 19 of the core drill 10 is lowered to the position so as to penetrate through the glass sheet 20 and be inserted into the annular cavity 42 formed on the stage 40, the inner peripheral end portion of the disk-shaped glass substrate 30 is ground at high precision.

Accordingly, the disk-shaped glass substrate 30 (product) is formed from the glass sheet 20.

Next, the disk-shaped glass substrate 30 (product) of which the inner peripheral edge portion is processed is extracted, and the residue of the glass sheet 20 from which the disk-shaped glass substrate 30 is extracted is removed from the stage 40 (Procedure B4). The extracted disk-shaped glass substrate 30 is transported to be subjected to a subsequent operation (chamfering of the inner periphery and the outer periphery, or grinding of the inner periphery, the outer periphery, and upper and lower surfaces of the substrate).

Next, swarf (cullet) remaining on the stage 40 is removed by the air blower (Procedure B5). The air blower blows a spiral air flow toward the stage while turning an air nozzle to effectively blow the swarf collected in the annular cavity 42 formed on the stage 40 upwards. Furthermore, a gas other than compressed air (for example, nitrogen gas) may be blown toward the stage 40, or, instead of the air blower, a liquid (fluid) such as a cutting fluid or a wash fluid may be sprayed toward the stage 40 to remove the swarf from the stage 40.

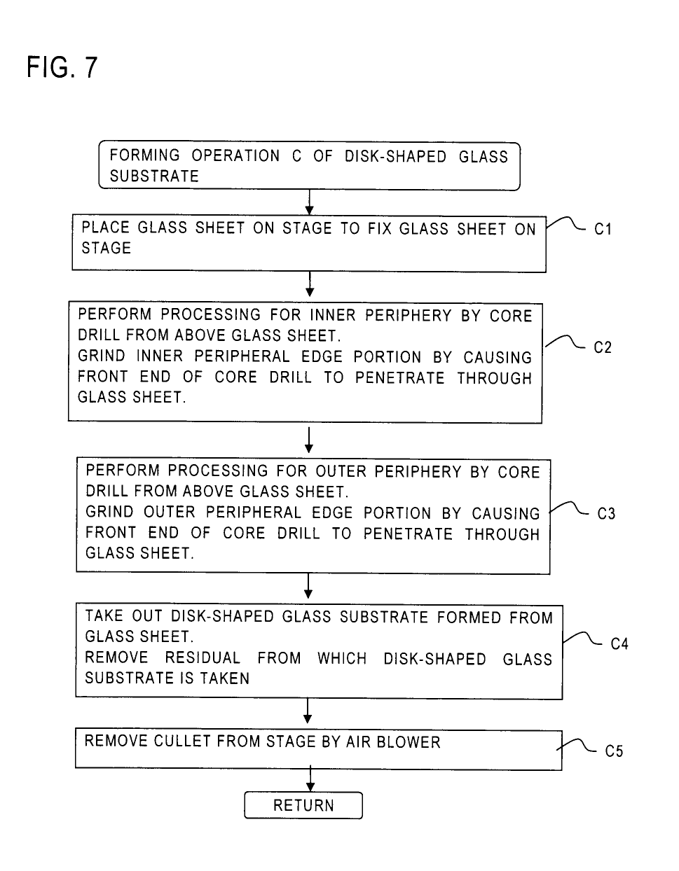

Next, a forming operation C according to a modified example will be described. FIG. 7 is a flowchart showing procedures of the forming operation C using the method of manufacturing a disk-shaped glass substrate according to the invention.

As shown in FIG. 7, first, the glass sheet 20 before being subjected to processing is placed on the stage 40 of the apparatus for processing a disk-shaped glass substrate, and the glass sheet 20 is vacuumed to be fixed on the stage 40 (Procedure C1).

Next, groove processing for the inner periphery to be provided in the disk-shaped glass substrate 30 is performed by the small-diameter core drill for processing an inner periphery from above the glass sheet 20 (Procedure C2). The small-diameter core drill is formed so that a front end portion of a grinding portion has a contour shape curved into an arc shape like the front end portion 19 of the grinding portion 18 of the above-mentioned core drill 10. In addition, in an operation of grinding the glass sheet, a grinding fluid such as a coolant is supplied to cool processed portions with which the grinding portion of the core drill comes in contact.

In addition, in Procedure C2, the front end portion 19 of the small-diameter core drill is lowered to a position so as to penetrate through the glass sheet 20 and be inserted into the annular cavity 42 formed on the stage 40, and thereafter the small-diameter core drill is lifted so as to be separated from the glass sheet 20. Processing for the inner periphery of the disk-shaped glass substrate 30 is terminated by a single processing with using the small-diameter core drill.

In addition, in Procedure C2, since the front end portion 19 of the core drill 10 is lowered to the position so as to penetrate through the glass sheet 20 and be inserted into the annular cavity 42 formed on the stage 40, the inner peripheral end portion of the disk-shaped glass substrate 30 is ground at high precision.

In the case of the manufacturing method illustrated in FIG. 7, after the inner periphery of the disk-shaped glass substrate 30 is processed from above, while fragments of the center hole are not removed, the outer periphery is processed from above as it is, and finally the disk-shaped glass substrate 30 is extracted.

Next, groove processing for the outer periphery to be provided in the disk-shaped glass substrate 30 is performed by the core drill 10 for processing an outer periphery from above the glass sheet 20 (Procedure C3). In addition, in Procedure C3, the front end portion 19 of the core drill 10 is lowered to a position so as to penetrate through the glass sheet 20 and be inserted into the annular cavity 42 formed on the stage 40, and thereafter the core drill 10 is lifted so as to be separated from the glass sheet 20. Processing for the outer periphery of the disk-shaped glass substrate 30 is terminated by a single processing with using the core drill 10.

In addition, in Procedure C3, since the front end portion 19 of the core drill 10 is lowered to the position so as to penetrate through the glass sheet 20 and be inserted into the annular cavity 42 formed on the stage 40, the outer peripheral end portion of the disk-shaped glass substrate 30 is ground at high precision. Accordingly, the disk-shaped glass substrate 30 (product) is formed from the glass sheet 20.

Next, the disk-shaped glass substrate 30 (product) is extracted from the glass sheet 20, and the residue of the glass sheet 20 from which the disk-shaped glass substrate 30 is extracted is removed from the stage 40 (Procedure C4). The extracted disk-shaped glass substrate 30 is transported to be subjected to a subsequent operation (chamfering of the inner periphery and the outer periphery, or grinding of the inner periphery, the outer periphery, and upper and lower surfaces of the substrate).

Next, swarf (cullet) remaining on the stage 40 is removed by the air blower (Procedure C5). The air blower blows a spiral air flow toward the stage 40 while turning the air nozzle to effectively blow the swarf collected in the annular cavity 42 formed on the stage 40 upwards. Furthermore, a gas other than the compressed air (for example, nitrogen gas) may be blown toward the stage 40, or, instead of the air blower, a liquid (fluid) such as a cutting fluid or a wash fluid may be sprayed toward the stage 40 to remove the swarf from the stage 40.

In addition, during the inner periphery processing in Procedure C2, for example, a method of stacking a number of the glass sheets to form a stacked body and collectively forming the plurality of inside diameters of the substrates may be used. In this case, since the inner periphery processing and the outer periphery processing are performed by different grinding apparatuses, a manipulation for adjusting positions on the stage needs to be performed in order to maintain circularity from roundness and concentricity before the grinding process.

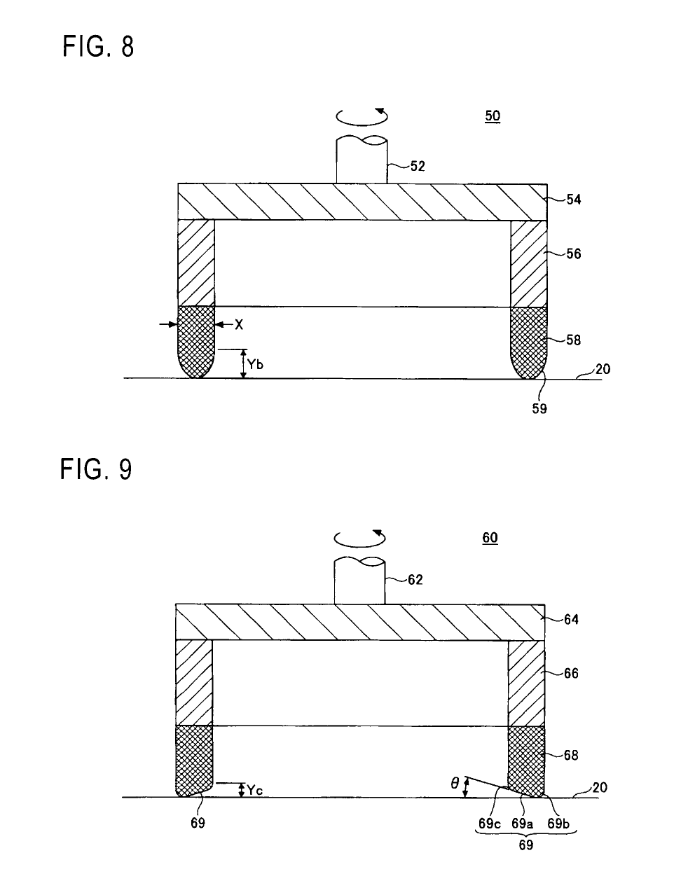

FIG. 8 is a longitudinal cross-sectional view illustrating a first modified example of the core drill. As illustrated in FIG. 8, a core drill 50 includes a rotation shaft 52, a supporting plate 54, a cylindrical portion 56, and a grinding portion 58, and a longitudinal cross-section of a front end portion 59 of the grinding portion 58 is formed in an elliptical shape. Therefore, a contour shape of the front end portion 59 in the first modified example is a parabolic shape in which a plurality of arcs having different radiuses of curvature are continuous.

In the first modified example, diamond abrasive grains are firmly fixed to a surface of the grinding portion 58 of the core drill 50 using metallic bonding. Accordingly, the core drill 50 can be formed so that a layer of the diamond abrasive grains of the grinding portion 58 is thicker than that formed by diamond electrodepositing, thereby enhancing durability of grinding.

In addition, grain sizes of the diamond abrasive grains of the grinding portion 58 may be in the range of fine count #100 to #400. Accordingly, the diamond abrasive grains of the core drill 50 are fine, thereby crack generation is suppressed when a thin glass sheet with a thickness of 1.5 mm or less is ground by the grinding portion 58, and most of the cracking is confined to the drill width and is thus corrected. Furthermore, in a case where the diamond abrasive grains of the grinding portion 58 exceed fine count #400, since the diamond abrasive grains are too fine, there are concerns that clogging and a reduction in grinding speed are likely to occur, and productivity is degraded.

The bottom portion of the processing groove 21 processed by the core drill 50 has a curved shape (parabolic shape), as is the same case as in the above-mentioned core drill 10, so that stress concentration on the processed surface does not occur and crack generation is suppressed during processing. Although a crack occurs, most of the cracking is confined to the drill width and thus can be corrected.

The front end portion 59 is formed to be at a position of an axial height Yb, and when the disk-shaped glass substrate 30 is formed by processing grooves 21 on the glass sheet 20, the front end portion 59 is inserted until the portion of the height Yb penetrates through the glass sheet 20 and protrudes from the lower surface of the glass sheet 20. Furthermore, the front end portion 59 of the core drill 50 has a wider axial height Yb than that of the above-mentioned core drill 10 (Yb>Ya), thereby setting a longer stroke (an elevating displacement of the core drill) in the up and down direction during processing.

FIG. 9 is a longitudinal cross-sectional view illustrating a second modified example of the core drill. As illustrated in FIG. 9, a core drill 60 includes a rotation shaft 62, a supporting plate 64, a cylindrical portion 66, and a grinding portion 68, and a longitudinal cross-section of a front end portion 69 of the grinding portion 68 is formed in a combined shape of arc and trapezoidal shapes. Therefore, a contour shape of the front end portion 69 in the second modified example is a trapezoidal shape in which a plurality of arcs having different radiuses of curvature and an inclined portion are continuous.

The front end portion 69 of the grinding portion 68 includes an inclined surface 69a which is inclined at a predetermined angle (angle θ) for the surface of the glass sheet 20, an outer arc-shaped portion 69b provided outside the inclined surface 69a, and an inner arc-shaped portion 69c provided inside the inclined surface 69a.

In this modified example, diamond abrasive grains are firmly fixed to a surface of the grinding portion 68 of the core drill 60 using metallic bonding. Accordingly, the core drill 60 can be formed so that a layer of the diamond abrasive grains of the grinding portion 68 is thicker than that formed by diamond electrodepositing, thereby enhancing durability of grinding.

In addition, grain sizes of the diamond abrasive grains of the grinding portion 68 may be in the range of fine count #100 to #400. Accordingly, the diamond abrasive grains of the core drill 60 are fine, thereby crack generation is suppressed when a thin glass sheet with a thickness of 1.5 mm or less is ground by the grinding portion 68, and most of the cracking is confined to the drill width and is thus modified. Furthermore, in a case where the diamond abrasive grains of the grinding portion 68 exceed fine count #400, since the diamond abrasive grains are too fine, there are concerns that clogging and a reduction in grinding speed are likely to occur, and productivity is degraded.

When the glass sheet 20 is processed by the core drill 60, first, the outer arc-shaped portion 69b initially comes in contact with the glass sheet 20, and as the core drill 60 is lowered, a cutting width formed on the glass sheet 20 is gradually increased. As the core drill 60 is further lowered, the inclined surface 69a also starts coming in contact with the glass sheet 20, so that the cutting width formed on the glass sheet 20 is gradually increased. As the core drill 60 is lowered, the inner arc-shaped portion 69c comes in contact with the glass sheet 20, and the front end portion 69 of the grinding portion 68 grinds the surface of the glass sheet 20 to form the processing groove 21, so that the groove width of the processing groove 21 is increased to the drill width X of the grinding portion 68.

Therefore, the bottom portion of the processing groove 21 processed by the core drill 60 has a combined shape of curved surfaces as is the same case as in the above-mentioned core drill 10, so that stress concentration on the processed surface does not occur and crack generation is suppressed during processing.

The front end portion 69 is formed to be at a position of an axial height Yc, and when the disk-shaped glass substrate 30 is formed by processing grooves 21 on the glass sheet 20, the front end portion 69 is inserted until the portion of the height Yc penetrates through the glass sheet 20 and protrudes from the lower surface of the glass sheet 20.

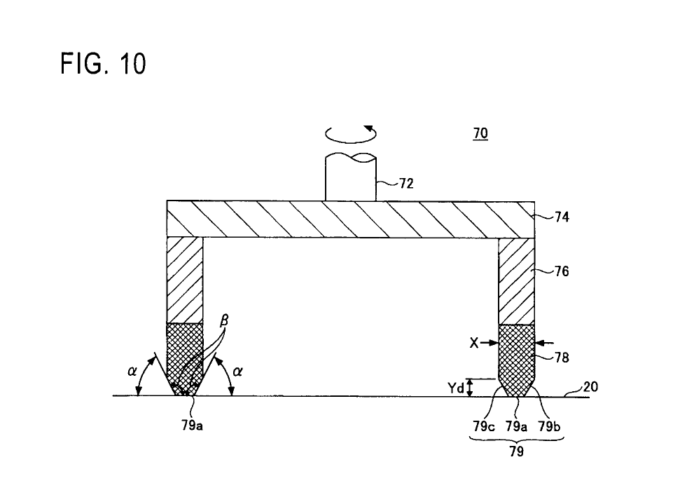

FIG. 10 is a longitudinal cross-sectional view illustrating a third modified example of the core drill. As illustrated in FIG. 10, a core drill 70 includes a rotation shaft 72, a supporting plate 74, a cylindrical portion 76, and a grinding portion 78, and a longitudinal cross-section of a front end portion 79 of the grinding portion 78 is formed in a chamfered shape in which corners of a rectangle are chamfered. Therefore, a contour shape of the front end portion 79 in the third modified example includes a narrow portion 79a which initially comes in contact with the surface of the glass sheet 20, an inclined portion 79b inclined on the outer peripheral side of the narrow portion 79a, and an inclined portion 79c inclined on the inner peripheral side of the narrow portion 79a.

When the glass sheet 20 is processed by the core drill 70 according to the third modified example, first, the narrow portion 79a initially comes in contact with the glass sheet 20. As the core drill 70 is lowered, the inclined portions 79b and 79c process the processing groove 21 on the surface of the glass sheet 20, and thus a cutting width of the processing groove 21 is gradually increased. As the core drill 70 is further lowered and the front end portion 79 penetrates through the glass sheet 20, the groove width of the processing groove 21 is increased to the drill width X of the grinding portion 78.

In addition, inclination angles α of the inclined portions 79b and 79c are set to, for example, 45° to 60°, so that angles β between the narrow portion 79a and the inclined portions 79b and 79c are set to be obtuse angles (for example, β=120° to 135°). Therefore, the bottom portion of the processing groove 21 processed by the core drill 70 has the obtuse-angled shape corresponding to the contour shape of the front end portion 79 of the grinding portion 78, so that stress concentration on the processed surface does not occur and crack generation is suppressed during processing.

The front end portion 79 is formed to a position of an axial height Yd, and when the disk-shaped glass substrate 30 is formed by processing grooves 21 on the glass sheet 20, the front end portion 79 is inserted until the portion of the height Yd penetrates through the glass sheet 20 and protrudes from the lower surface of the glass sheet 20.

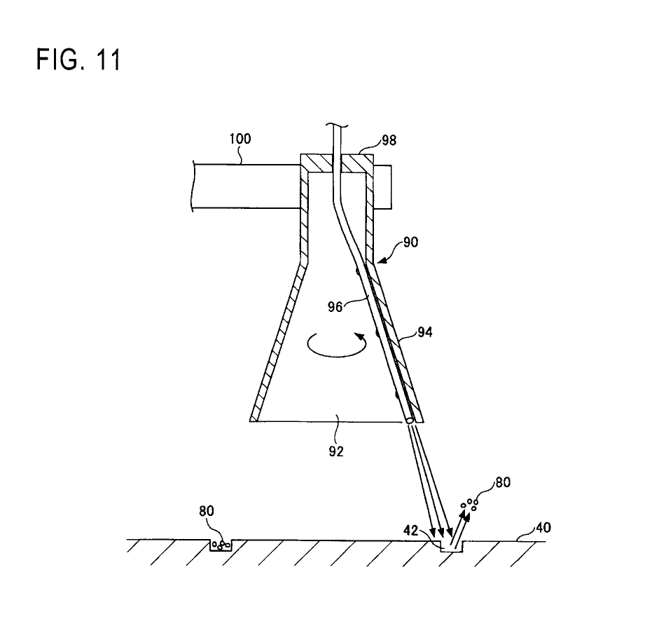

FIG. 11 is a diagram illustrating an operation of removing cullet (swarf) on the stage. As illustrated in FIG. 11, in Procedures A7, B5, and C5 described above, swarf 80 on the stage 40 is removed by an air flow blown by an air nozzle 90. The air nozzle 90 includes a guide portion 94 which is formed in a tapered shape so that an opening 92 has a large diameter, and an air blowing tube 96 inserted through an inside of the guide portion 94 having the tapered shape. An upper end of the air blowing tube 96 is inserted through a center hole of an upper end wall portion 98 of the air nozzle 90 and is also firmly fixed thereto. Furthermore, in order to enhance wear resistance of slidably contacting portions of the air blowing tube 96, a fixed portion thereof which is inserted through the center hole of the upper end wall portion 98 to be held and a turning portion which is corrected by an inner wall of the guide portion 94 having the tapered shape may be covered by a resin pipe.

In addition, when the compressed air is supplied to the air blowing tube 96, due to reaction of the compressed air blown from the opening of the front end portion of the air blowing tube 96, the air blowing tube 96 itself is elastically deformed and curved so as to follow the inner wall of the guide portion 94 having the tapered shape and is thus subjected to a torsional movement. Therefore, the front end portion of the air blowing tube 96 starts a turning movement along an inner peripheral surface of the guide portion 94. Accordingly, the compressed air blown from the opening of the front end portion of the air blowing tube 96 is blown in an extension direction of the inner peripheral surface of the guide portion 94 and simultaneously is blown toward the stage 40 as a turning flow due to the turning operation of the front end portion of the air blowing tube 96.

An upper portion of the air nozzle 90 is supported by a bracket 100. Therefore, by adjusting a height of the bracket 100, an extended line of an inclination angle of the guide portion 94 with respect to an axial line in the vertical direction coincides with the annular cavity 42 formed on the stage 40. Accordingly, the air flow becomes such a turning flow that the blowing position of the compressed air due to the turning operation of the front end portion of the air blowing tube 96 follows the formation position of the annular cavity 42.

Accordingly, the swarf 80 remaining in the annular cavity 42 is effectively removed from the stage 40 by the turning flow of the compressed air that occurs due to the turning operation of the air blowing tube 96. Accordingly, when the next glass sheet 20 is fixed on the stage 40, the swarf is not stuck between the glass sheet 20 and the stage 40, and the glass sheet 20 can be made to closely contact to the stage 40 without a gap.

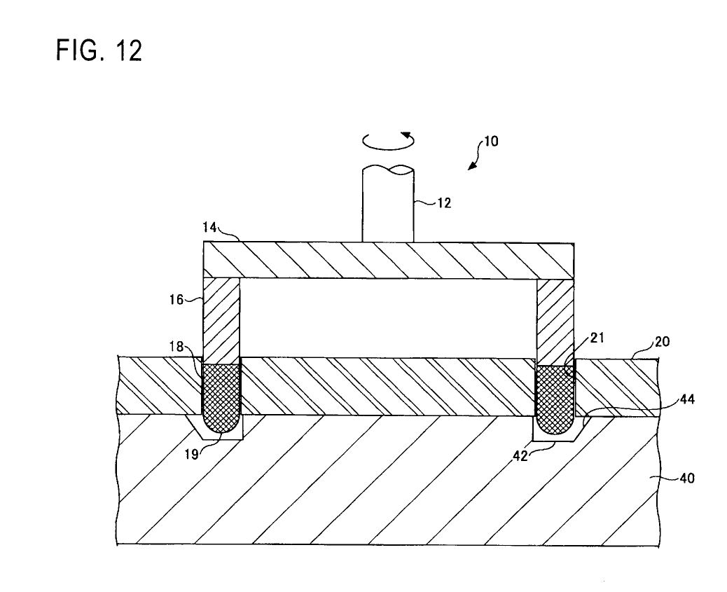

FIG. 12 is a longitudinal cross-sectional view illustrating a modified example of the annular cavity formed on the stage. As illustrated in FIG. 12, on the outer peripheral side of the annular cavity 42, an inclined surface 44 which connects the bottom portion of the annular cavity 42 to the upper surface of the stage 40 is provided. The inclined surface 44 forms a space in which swarf is collected when the front end portion 19 of the grinding portion 18 of the core drill 10 penetrates through the glass sheet 20, and is adapted to cause the swarf to be easily blown upwards when the compressed air is blown by the above-mentioned air nozzle 90.

The inclined surface 44 is provided on the opposite side to the disk-shaped glass substrate 30 when the disk-shaped glass substrate 30 is formed from the glass sheet 20 as a product. For example, in a case where the core drill 10 processes the outer peripheral side of the disk-shaped glass substrate 30, the inclined surface 44 is provided on the outer peripheral side of the annular cavity 42, and in a case where the core drill 10 processes the inner peripheral side of the disk-shaped glass substrate 30, the inclined surface 44 is provided on the inner peripheral side of the annular cavity 42.

Accordingly, it is possible to ensure supporting portions for supporting outer and inner peripheral edges from the lower surface of the disk-shaped glass substrate 30 on the stage 40, and it is possible to effectively remove the swarf 80 from the upper surface of the stage 40 on which the glass sheet 20 is fixed. Therefore, when the next glass sheet 20 is fixed on the stage 40, the swarf is reliably prevented from being stuck between the glass sheet 20 and the stage 40, and the glass sheet 20 can be made to closely contact to the stage 40 without a gap.

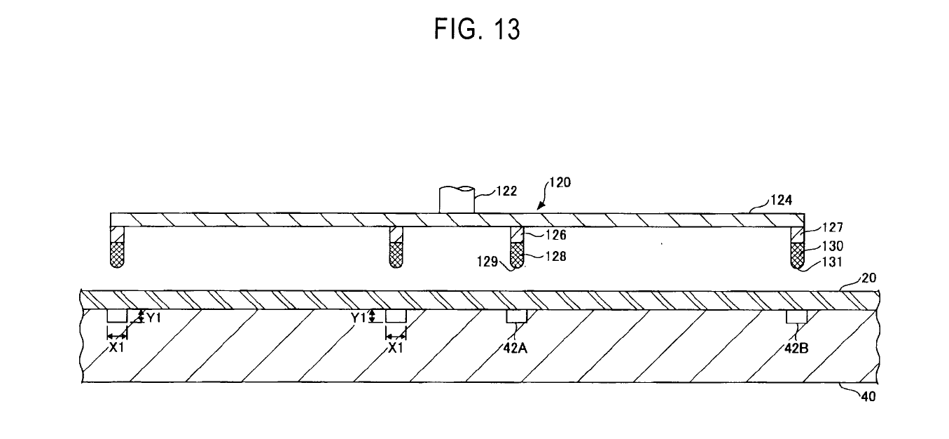

FIG. 13 is a longitudinal cross-sectional view illustrating a core drill and the stage for processing the inner and outer peripheries of the disk-shaped glass substrate. As illustrated in FIG. 13, the core drill 120 includes a rotation shaft 122, a supporting plate 124, an inner peripheral side cylindrical portion 126, an outer peripheral side cylindrical portion 127, an inner peripheral side processing grinding portion 128, and an outer peripheral side processing grinding portion 130. The inner peripheral side processing grinding portion 128 and the outer peripheral side processing grinding portion 130 are formed to have the same concentricity (the same rotation center). The inner peripheral side processing grinding portion 128 is a grinding portion for processing the inner periphery of the disk-shaped glass substrate 30, and the outer peripheral side processing grinding portion 130 is a grinding portion for processing the outer periphery of the disk-shaped glass substrate 30.

A front end portion 129 of the inner peripheral side processing grinding portion 128 and a front end portion 131 of the outer peripheral side processing grinding portion 130 are formed to have the same shape as that of any one of the above-mentioned front end portions 19, 59, 69, and 79 of the core drills 10, 50, 60, and 70, respectively.

In addition, diamond abrasive grains are firmly fixed to surfaces of the inner and outer peripheral side processing grinding portions 128 and 130 of the core drill 120 using metallic bonding. Accordingly, the core drill 120 can be formed so that layers of the diamond abrasive grains of the inner and outer peripheral side processing grinding portion 128 and 130 are thicker than those formed by diamond electrodepositing, thereby enhancing durability of grinding.

In addition, grain sizes of the diamond abrasive grains of the inner and outer peripheral side processing grinding portions 128 and 130 may be in the range of fine count #100 to #400. Accordingly, the diamond abrasive grains of the core drill 120 are fine, thereby crack generation is suppressed when a thin glass sheet with a thickness of 1.5 mm or less is ground by the inner and outer peripheral side processing grinding portions 128 and 130.

Drill widths (thicknesses) X of the inner and outer peripheral side processing grinding portions 128 and 130 in the radial direction may be in the range of 0.5 mm to 2.0 mm, and radiuses of curvature of the front end portions 129 and 131 of the inner and outer peripheral side processing grinding portions 128 and 130 may be in the range of 0.1 mm to 0.5 mm. Accordingly, the front end portions 129 and 131 of the inner and outer peripheral side processing grinding portions 128 and 130 are formed to be ultrafine, and thus stress applied to the surface of the glass sheet is reduced when the thin glass sheet having a thickness of 1.5 mm or less is ground. Therefore, crack generation that may occur in the groove processing part is prevented, so that it is possible to process the thin glass sheet at high precision.

On the upper surface of the stage 40 on which the glass sheet 20 is placed, annular cavities 42A and 42B into which the front end portions 129 and 131 of the inner and outer peripheral side processing grinding portion 128 and 130 are respectively inserted are formed. The annular cavity 42A is provided to have the same diameter as that of the inner periphery of the disk-shaped glass substrate 30 or to form an outer peripheral edge portion outside the inner periphery of the disk-shaped glass substrate 30. The annular cavity 42B is provided to have the same diameter as that of the outer periphery of the disk-shaped glass substrate 30 or to form an inner peripheral edge portion inside the outer periphery of the disk-shaped glass substrate 30.

In addition, cavity widths X1 of the annular cavities 42A and 42B in the radial direction are wider than the drill width X of the front end portions 129 and 131 of the inner and outer peripheral side processing grinding portions 128 and 130 so that the annular cavities 42A and 42B do not come in contact with the front end portions 129 and 131 of the inner and outer peripheral side processing grinding portions 128 and 130. In this embodiment, the annular cavity 42 is formed so that the cavity width X1 in the radial direction is wider than the drill width X of the grinding portion 18 of the core drill 10 in the radial direction by 5% to 50%.

The edge portions of the inner and outer peripheral sides of the annular cavities 42A and 42B (edge portions of the upper surface of the stage 40) are respectively positioned very slightly inside and outside the drill width X of the grinding portions 128 and 130 of the core drill 120. Therefore, it is possible to suppress chip from expanding when the front end portions 129 and 131 of the inner and outer peripheral side processing grinding portions 128 and 130 penetrate through the glass sheet 20.

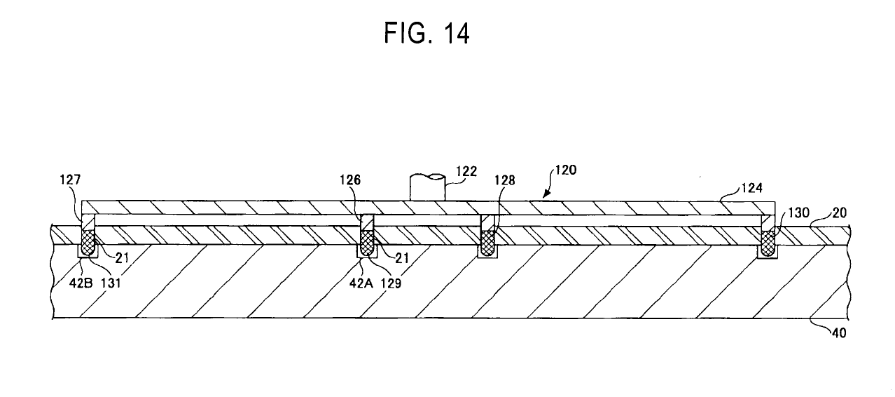

FIG. 14 is a longitudinal cross-sectional view illustrating a state where the inner periphery and the outer periphery of the disk-shaped glass substrate are processed with using the core drill illustrated in FIG. 13. As illustrated in FIG. 14, the depth Y1 of the annular cavities 42A and 42B in the up and down direction is wider than a protruding amount of the front end portions 129 and 131 of the inner and outer peripheral processing grinding portions 128 and 130 protruding downward from the lower surface of the glass sheet 20.

Accordingly, when the front end portions 129 and 131 of the inner and outer peripheral processing grinding portions 128 and 130 penetrate through the processing groove 21 while grinding the processing groove 21 in the glass sheet 20, swarf (cullet) due to the grinding falls in the annular cavities 42A and 42B and is prevented from scattering in the vicinity thereof.

In addition, since the annular cavities 42A and 42B are formed on the stage 40, the front end portions 129 and 131 of the inner and outer peripheral side processing grinding portions 128 and 130 are allowed to penetrate through the glass sheet 20. The inner and outer peripheral surfaces of the grinding portions 128 and 130 grind the inner and outer peripheral walls of the processing groove 21 while the front end portions 129 and 131 of the inner and outer peripheral side processing grinding portions 128 and 130 penetrate therethrough, so that it is possible to remove chip that may occur on the lower surface side of the glass sheet 20.

As such, in the core drill 120, the front end portions 129 and 131 of the inner and outer peripheral side processing grinding portions 128 and 130 simultaneously process the processing groove 21 on the surface of the glass sheet 20, so that a processing time can be significantly reduced.

Furthermore, in the core drill 120, a configuration may be employed in which a downward protruding length of the front end portion 129 of the inner peripheral side processing grinding portion 128 is smaller than that of the front end portion 131 of the outer peripheral side processing grinding portion 130 so that the outer peripheral side processing grinding portion 130 first processes the processing groove 21 on the glass sheet 20 and penetrates through the glass sheet 20 and thereafter the inner peripheral side processing grinding portion 128 processes the processing groove 21 on the glass sheet 20 and penetrates through the glass sheet 20.

In this case, a time difference occurs between grinding operations of the inner and outer peripheral side processing grinding portions 128 and 130, so that a load to the core drill 120 and the glass sheet 20 is reduced, thereby reducing chip and suppressing crack generation. In addition, it is also possible to change a rotation frequency of the core drill to set peripheral speeds of the inner and outer peripheral side processing grinding portions 128 and 130 so as to be the same so that wear amounts of the inner and outer peripheral side processing grinding portions 128 and 130 do not vary due to the peripheral speed difference.

A difference between protruding lengths of the inner and outer peripheral side processing grinding portions 128 and 130 may be provided to cause the outer peripheral side processing grinding portion 130 to penetrate through the glass sheet 20 in advance of the inner peripheral side processing grinding portion 128, and the length of the annular cavity 42B on the outer side is set to be wider than that of the annular cavity 42A on the inner side according to the difference between the protruding lengths.

A supporting plate for supporting the inner peripheral side processing grinding portion 128 and a supporting plate for supporting the outer peripheral side processing grinding portion 130 may be individually provided and rotation shafts for rotating the supporting plates are concentrically disposed. The rotation shafts function as driving mechanisms for rotating their individual motors, and rotation frequencies of the rotation shafts may be controlled so that the peripheral speeds of the inner and outer peripheral side processing grinding portions 128 and 130 are the same.

The core drill 120 may be manufactured so that the outer peripheral side processing grinding portion 130 is set to have higher durability than the inner peripheral side processing grinding portion 128. Accordingly, even though the processing for the inner periphery and the processing for the outer periphery are performed at the same rotation frequency, the outer peripheral side processing grinding portion 130 having higher peripheral speed is not worn and deformed faster than the inner peripheral side processing grinding portion 128.

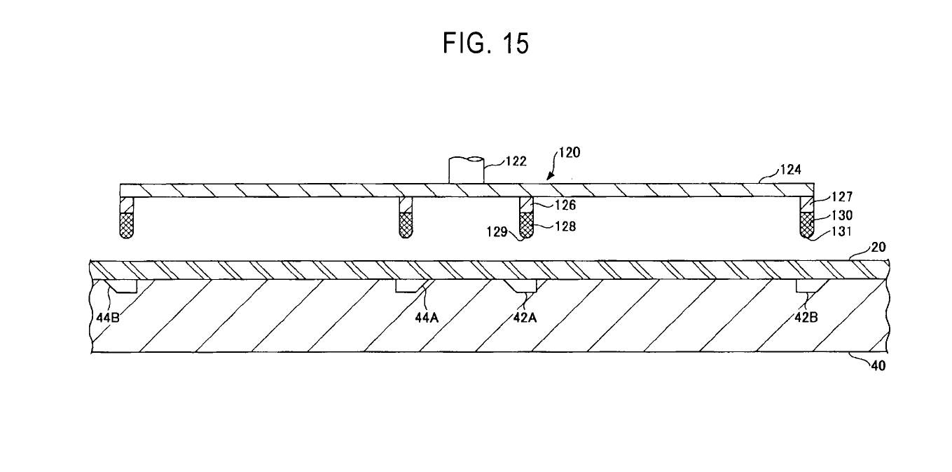

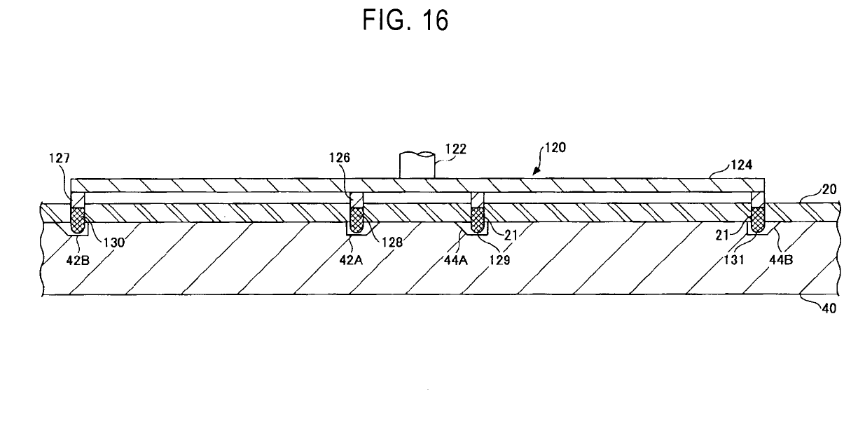

FIG. 15 is a longitudinal cross-sectional view illustrating a modified example of the annular cavity formed on the stage when the inner and outer peripheries of the disk-shaped glass substrate are processed with using the core drill. FIG. 16 is a longitudinal cross-sectional view illustrating a state where the inner and outer peripheries of the disk-shaped glass substrate are processed with using the core drill illustrated in FIG. 15.

As illustrated in FIG. 15, on the upper surface of the stage 40, inclined surfaces 44A and 44B for connecting the bottom portions of the annular cavities 42A and 42B into which the front end portions 129 and 131 of the inner and outer peripheral side processing grinding portions 128 and 130 are respectively inserted into the upper surface of the stage 40. The inclined surface 44A on one side is provided on the inner peripheral side of the annular cavity 42A, and the inclined surface 44B on the other side is provided on the outer peripheral side of the annular cavity 42B. That is, the inclined surfaces 44A and 44B are provided at positions that are not opposed to the disk-shaped glass substrate 30 which is a product from the glass sheet 20.

As illustrated in FIG. 16, when the front end portions 129 and 131 of the inner and outer peripheral side processing grinding portions 128 and 130 penetrate through the glass sheet 20, chip that may occur in the lower surface of the glass sheet 20 on the outer peripheral side of the annular cavity 42A and the inner peripheral side of the annular cavity 42B which are included in the disk-shaped glass substrate 30 can be suppressed. Accordingly, as illustrated in FIG. 5, it is possible to suppress the chip 34 that occurs on the lower surface side of the processing groove 21 to be smaller than the ranges of the processing allowances 32a, 32b, and 32c.

In addition, since the inclined surfaces 44A and 44B are provided in the annular cavities 42A and 42B, when the turning flow of the compressed air is blown by the above-mentioned air nozzle 90, it is possible to effectively remove swarf collected in the annular cavities 42A and 42B toward the outside of the annular cavities 42A and 42B. Accordingly, when the next glass sheet 20 is fixed on the stage 40, the swarf is reliably prevented from being stuck between the glass sheet 20 and the stage 40, and the glass sheet 20 can be made closely contact to the stage 40 without a gap. Next, a method of manufacturing a glass substrate for a magnetic recording medium and a magnetic disk will be described.

In general, operations of manufacturing a glass substrate for a magnetic recording medium and a magnetic disk include the following operations.

(Operation 1) A glass sheet formed by a float process, a fusion process, or a press-forming process is processed to have a disk shape with a circular hole at the center, and inner and outer peripheral sides thereof are subjected to chamfering.

(Operation 2) A side portion of the glass substrate and the chamfered portion are subjected to end-surface grinding.

(Operation 3) A main surface of the glass substrate is ground. With regard to the grinding operation, primary grinding operation may be performed, primary and secondary grinding may be performed, and tertiary grinding may be performed after the secondary grinding.

(Operation 4) The glass substrate is subjected to precision cleaning, thereby obtaining the glass substrate for a magnetic disk.

(Operation 5) A thin film such as a magnetic layer is formed on the glass substrate for a magnetic recording medium to manufacture a magnetic disk.

In the operations of manufacturing the glass substrate for a magnetic recording medium and the magnetic disk, lapping of the main surface (for example, free abrasive grain lapping, fixed abrasive grain lapping, and the like) may be performed on at least one of either before and after the end-surface grinding operation (in Operation 2), or cleaning of the glass substrate (in-operation cleaning) or etching of the surface of the glass substrate (in-operation etching) may be performed between the operations. The lapping of the main surface (for example, free abrasive grain lapping, fixed abrasive grain lapping, and the like) is grinding of the main surface in a broad sense.

Moreover, in a case where high mechanical strength is required for the glass substrate for a magnetic disk, a toughening operation for forming a toughened layer on the surface of the glass substrate (for example, a chemically toughening operation) may be performed before the grinding operation, after the grinding operation, or in the grinding operation.

According to the invention, the glass substrate for a magnetic disk may be made of an amorphous glass, a crystallized glass, or a toughened glass having a toughened layer on the surface of the glass substrate (for example, a chemically toughened glass). The glass sheet of the glass substrate according to the invention may be made of a float process, a fusion process, or a press-forming process.

In the above embodiments, the case where the disk-shaped glass substrate used as the glass substrate for a magnetic recording medium has been described. However, the invention is not limited to this and may also be applied to a case where a disk-shaped glass substrate used for an object other than the glass substrate for a magnetic recording medium is formed.

What is claimed is:

1. A method of manufacturing a disk-shaped glass substrate comprising:
placing a glass sheet with a thickness of 1.5 mm or less on a stage; and
forming a disk-shaped glass substrate from the glass sheet with using a cylinder-shaped core drill,
wherein the core drill has a front end portion configured to cut a surface of the glass sheet, the front end portion has a contour shape which is inclined or curved in a radial direction for the surface of the glass sheet, and
wherein an annular cavity into which the front end portion of the core drill is to be inserted is formed on a surface of the stage on which the glass sheet is to be fixed.

2. The method according to claim 1, wherein in the forming of the disk-shaped glass substrate from the glass sheet with using the core drill, the front end portion of the core drill is inserted into the glass sheet while forming a groove having a shape corresponding to the contour shape of the front end portion on the surface of the glass sheet, and then the front end portion of the core drill penetrates through the glass sheet.

3. The method according to claim 1, wherein a cavity width of the annular cavity on the stage in a radial direction is wider than a drill width of the core drill in the radial direction by 5% to 50%.

4. The method according to claim 1, wherein a radius of curvature of the front end portion of the core drill is in a range of 0.1 mm to 0.5 mm.

5. The method according to claim 1, wherein diamond abrasive grains are firmly fixed to a surface of the front end portion of the core drill using metallic bonding, and the drill width of the core drill in the radial direction is in a range of 0.5 mm to 2.0 mm.

6. The method according to claim 1, further comprising:
removing glass cullet, which occurs in the forming of the disk-shaped glass substrate from the glass sheet with using the core drill, from the stage.

7. The method according to claim 6, wherein the removing of the glass cullet from the stage includes blowing a fluid toward the annular cavity formed on the stage.

8. The method according to claim 1, wherein the disk-shaped glass substrate is used as a glass substrate for a magnetic recording medium.

9. The method according to claim 1, wherein the forming of the disk-shaped glass substrate from the glass sheet with using the core drill include at least one of an outside diameter processing or an inside diameter processing of the disk-shaped glass substrate.

10. The method according to claim 1,
wherein the annular cavity on the stage includes an inner peripheral edge portion which has the same dimension as a diameter of an outer periphery of the disk-shaped glass substrate or which is positioned inside the outer periphery of the disk-shaped glass substrate, or includes an outer peripheral edge portion which has the same dimension as a diameter of an inner periphery of the disk-shaped glass substrate or which is positioned outside the inner periphery of the disk-shaped glass substrate.

11. The method according to claim 1,
wherein the annular cavity formed on the stage is provided on the inner peripheral side and/or on the outer peripheral side of the disk-shaped glass substrate,
wherein the annular cavity on the inner peripheral side includes a tapered surface in which its inner peripheral edge portion is inclined toward the inside, and
wherein the annular cavity on the outer peripheral side includes a tapered surface in which its outer peripheral edge portion is inclined toward the outside.

12. The method according to claim 9,
wherein the forming of the disk-shaped glass substrate from the glass sheet with using the core drill includes the outside diameter processing and the inside diameter processing of the disk-shaped glass substrate,
wherein the outside diameter processing and the inside diameter processing of the disk-shaped glass substrate are performed on the same stage.

13. A disk-shaped glass substrate which is processed by the method according to claim 1,
wherein a size of a crack formed on a cut section of the disk-shaped glass substrate in the forming of a disk-shaped glass substrate from the glass sheet with using the core drill is equal to or smaller than 0.3 mm in a main surface direction of the disk-shaped glass substrate and is equal to or smaller than 0.15 mm in a thickness direction of the disk-shaped glass substrate.

14. A disk-shaped glass substrate which is processed by the method according to claim 1,
wherein circularity from roundness of an inside diameter of the disk-shaped glass substrate is equal to or smaller than 15 μm, circularity from roundness of an outside diameter of the disk-shaped glass substrate is equal to or smaller than 15 μm, and concentricity of the inside and outside diameters is equal to or smaller than 50 μm.

15. A disk-shaped glass substrate which is processed by the method according to claim 1,
wherein a size of a crack formed on a cut section of the disk-shaped glass substrate in forming of a disk-shaped glass substrate with using the core drill is equal to or smaller than 0.3 mm in a main surface direction of the disk-shaped glass substrate and is equal to or smaller than 0.15 mm in a thickness direction of the disk-shaped glass substrate, and
circularity from roundness of an inside diameter of the disk-shaped glass substrate is equal to or smaller than 15 μm, circularity from roundness of an outside diameter of the disk-shaped glass substrate is equal to or smaller than 15 μm, and concentricity of the inside and outside diameters is equal to or smaller than 50 μm.

16. A glass substrate for a magnetic recording medium, having a disk shape with a circular hole in a center portion,
wherein circularity from roundness of an inside diameter of the glass substrate for a magnetic recording medium is equal to or smaller than 15 μm, circularity from roundness of an outside diameter of the glass substrate for a magnetic recording medium is equal to or smaller than 15 μm, and concentricity of the inside and outside diameters is equal to or smaller than 50 μm.
